(19) United States
(12) Patent Application Publication
(10) Pub. No.: US 2023/0410487 A1
(43) Pub. Date: Dec. 21, 2023

(54) ONLINE LEARNING METHOD AND SYSTEM FOR ACTION RECOGNITION

(71) Applicant: Intel Corporation, Santa Clara, CA (US)

(72) Inventors: Lidan Zhang, Beijing (CN); Qi She, Beijing (CN); Ping Guo, Beijing (CN); Yimin Zhang, Beijing (CN)

(73) Assignee: Intel Corporation, Santa Clara, CA (US)

(21) Appl. No.: 18/250,498

(22) PCT Filed: Nov. 30, 2020
(86) PCT No.: PCT/CN2020/132814

§ 371 Date: Apr. 25, 2023

(51) Int. Cl. G06V 10/778; G06V 20/40; G06V 10/82; G06V 40/20

(52) U.S. Cl. CPC G06V 10/778; G06V 20/41; G06V 20/44; G06V 10/82; G06V 40/20; G06V 20/46

(57) ABSTRACT

Performing online learning for a model to detect unseen actions in an action recognition system is disclosed. The method includes extracting semantic features in a semantic domain from semantic action labels, transforming the semantic features from the semantic domain into mixed features in a mixed domain, and storing the mixed features in a feature database. The method further includes extracting visual features in a visual domain from a video stream and determining if the visual features indicate an unseen action in the video stream. If no unseen action is determined, applying an offline classification model to the visual features to identify seen actions, assigning identifiers to the identified seen actions, transforming the visual features from the visual domain into mixed features in the mixed domain, and storing the mixed features and seen action identifiers in the feature database. If an unseen action is determined, transforming the visual features from the visual domain into mixed features in the mixed domain, applying a continual learner model to mixed features from the feature database to identify unseen actions in the video stream, assigning identifiers to the identified unseen actions, and storing the unseen action identifiers in the feature database.

### CLAIM OF PRIORITY

This application claims, under 35 U.S.C. § 371, the benefit of and priority to International Application No. PCT/CN2020/132814, filed Nov. 30, 2020, titled ONLINE LEARNING METHOD AND SYSTEM FOR ACTION RECONGITION, the entire content of which is incorporated herein by reference.

### FIELD

Embodiments relate generally to machine learning and computer vision in computing systems, and more particularly, to an online learning method and system for recognitions of actions in video data.

### BACKGROUND

Action recognition is the process of detecting and identifying the actions of an agent in a video stream. The agent can be a single agent performing the action or groups of agents performing the actions or having some interactions. Human action recognition has received much attention and gained popularity since it has usefulness in several practical applications (e.g., health care, entertainment and surveillance systems). Since many deployed cameras are networked, computer vision-based action recognition methods provide advantages when naturally integrated into artificial intelligence (AI) based solutions. Furthermore, action recognition based on computer vision (e.g., deep learning-based methods) require little human intervention or physical contact with humans (e.g., using wearable devices).

Computer vision-based action recognition methods follow the de facto process of deep learning: 1) existing models are trained offline with predefined action types, and then deployed for inference (e.g., with no online learning or updating of the models), and 2) existing models are only effective with a closed set of pre-defined actions, and do not have the capability of open set recognition of previously unseen action types (e.g., unseen actions being those that the models have not been trained offline to detect).

### BRIEF DESCRIPTION OF THE DRAWINGS

So that the manner in which the above recited features of the present embodiments can be understood in detail, a more particular description of the embodiments, briefly summarized above, may be had by reference to embodiments, some of which are illustrated in the appended drawings. It is to be noted, however, that the appended drawings illustrate only typical embodiments and are therefore not to be considered limiting of its scope. The figures are not to scale. In general, the same reference numbers will be used throughout the drawings and accompanying written description to refer to the same or like parts.

FIG. 1 illustrates an action recognition system according to some embodiments.

FIG. 2 is a diagram of a core set engine according to some embodiments.

FIG. 3 is a diagram of machine learning (ML) models and transfer policies according to some embodiments.

FIG. 4 illustrates domain transformations for visual, semantic and mixed features according to some embodiments.

FIG. 5 is a flow diagram of an action recognition system according to some embodiments.

FIG. 6 is a flow diagram of action recognition processing according to some embodiments.

FIG. 7 illustrates a computing device employing an action recognition system, according to an embodiment.

FIG. 8 illustrates a machine learning software stack, according to an embodiment.

FIG. 9 illustrates an exemplary inferencing system on a chip (SOC) suitable for performing action recognition according to some embodiments.

### DETAILED DESCRIPTION

Embodiments of the present invention provide a capability to detect human actions in a streaming video. Embodiments discern actions that have not yet been seen during offline training, adaptively handle transfer of domains from semantic to mixed and from visual to mixed and can learn incrementally with unseen action types. Embodiments also provide an online learning mechanism that updates models online during runtime. As used herein, an unseen action is an action contained in a video that a classification model has not been trained offline to detect.

Human action recognition aims to detect a spatial position and one or more actions of a human in a video stream. Human action recognition can be split into two sub-tasks: 1) action classification, and 2) human bounding box regression. Considering the complexity of action definitions and the manual labor required for annotating both action classes and person positions, existing approaches are not capable of training an offline deep learning model that can discern the actions for real world applications. However, embodiments of the present invention can discern actions that have not been seen in offline training and adaptively handle domain transfers.

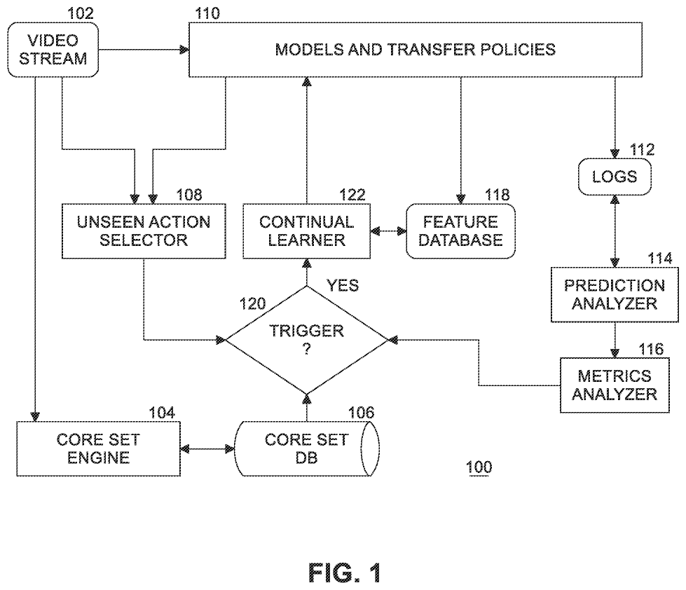

FIG. 1 illustrates an action recognition system 100 according to some embodiments. A video stream 102 is input to unseen action selector 108, core set engine 104, and models and transfer policies 110. Video stream includes a sequence of frames, each frame having a plurality of red-green-blue (RGB) pixel values. Unseen action selector 108 determines whether incoming video stream 102 includes human actions that have been previously seen during offline training of a classification model or have not yet been seen (e.g., classification models have not been trained to detect these actions). Unseen action selector 108 controls an update strategy for continual learner 122 via trigger 120. In an embodiment, unseen action selector 108 outputs a selection value of 1 if an action in the video stream has been seen (e.g., during offline training) or 0 if an action in the video stream has not yet been seen. In an embodiment, Unseen action selector 108 comprises a machine learning (ML) classifier with a binary output value. In an embodiment, unseen action selector 108 is implemented by maximizing the entropy of unseen action classes while smoothing the entropy of seen action classes. In one embodiment, visualization features from application of a classification model such as I3D (as described in “Quo Vadis Action Recognition? A New Model and Kinetics Dataset” by Jãao Carreira et al., published Feb. 12, 2018, Cornell University) are inputted into two fully-connected layers to generate a selector value. As used herein a feature is an object extracted from a video frame representing the appearance of something in the frame. In machine learning, pattern recognition and in image processing, feature extraction starts from an initial set of measured data and builds derived values (features) intended to be informative and non-redundant, facilitating the subsequent learning and generalization steps, and in some cases leading to better human interpretations. A classification model such as I3D includes a convolutional neural network (CNN) constructed by concatenating several layers. Here the “fully-connected layer” is a commonly used layer of the CNN. The entropy of this selector value is computed and compared to a predefined threshold to determine the selection value.

Training unseen action selector 108 requires additional unseen features. In one embodiment, a Wasserstein Generative Adversarial Network (WGAN) is used to generate some unseen visualization features from semantic features. The WGAN includes a generator and a discriminator, which both are implicated by two fully-connected layers. The semantic features and noise are input into the generator to generate the synthesized visualization features. The discriminator takes the synthesized/real visualization features and the semantic features to judge whether the features are synthesized or real. Based on the synthesized unseen visualization features and the real seen visualization features, the unseen action selector can be trained to decide whether the action in the input video stream 102 is seen or unseen.

Core set engine 104 analyzes video stream 102, extracts visualization features (which can be used to update feature database 118 by models 110) and stores selected key frame information in core set database (DB) 106. Core set DB 106 stores key frames and person positions. In an embodiment, core set engine 104 selects key frames from the video stream and uses an object detection system (such as a known YOLO model) to detect a person performing an action. In one embodiment, the YOLO model used is as described in “YOLO9000: Bigger, Faster, Stronger” by Joseph Redmon, et al., available on the Internet at pjreddie.com. Note that the YOLO model for person detection is not updated online, since human detection and analysis is more robust compared with ML action classification. In embodiments of the present invention, the online classification model is automatically updated with human intervention.

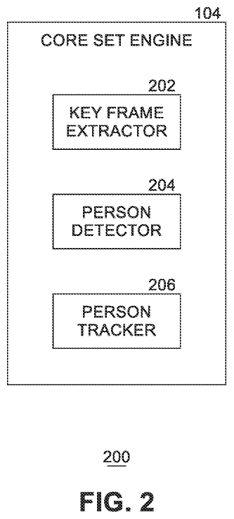

FIG. 2 is a diagram of core set engine 104 according to some embodiments. Core set engine 104 includes key frame extractor 202, person detector 204, and person tracker 206. Key frame extractor 202 extracts key frames from video stream 102. Key frames may include frames of the video stream where certain events happen, such as a new person appears in a scene of the video stream, a person exits from scene, or the person is moving within the scene, etc. Person detector 204 detects the position of all persons appearing in the video stream. In one embodiment, the YOLO9000 model is used. Person tracker 206 associates the same person across frames in the video stream. In one embodiment, a kernelized correlation filter (KCF) is used for tracking persons across frames (e.g., as described in “Performance Evaluation of KCF Based Trackers Using VOT Dataset” by Michael George, et al., 6^{th} International Conference on Smart Computing and Communications, ICSCC Proceedings, Dec. 7, 2017).

Prediction analyzer 114 reads and analyzes model performance data from logs 112 produced by models and transfer policies 110. In an embodiment, logs 112 include classification accuracy results and timestamp data. In an embodiment, model performance data includes, but is not limited to: frame information including action categories output from the models, ground-truth data labeled by human analyst and optionally classification intermediate results, such as positions of persons in frames of the video stream. Model performance data may also include computing system runtime profile information for the computing system executing the action recognition system 100, including processing speed and memory usage. Prediction analyzer 114 calculates an uncertainty metric data value measuring the confidence of a current action recognition result produced by a classification model and an accuracy metric data value measuring the accuracy of the current action recognition result produced by a classification model. In an embodiment, accuracy is computed dividing a number of correct frames by a total number of frames. Here, manually annotated labels are known for each frame, the action recognition system can distinguish if the current action recognition result is correct or not.

Prediction analyzer 114 calls metrics analyzer 116 to generate system profile results, such as speed, memory usage, etc. Metrics analyzer 116 sends evaluation results, such as classification accuracy to trigger 120 to assist in controlling activation of continual learner 122.

Trigger 120 determines whether to call continual learner 122. In an embodiment, trigger 120 calls continual learner 122 to perform online updating of models and transfer policies 110 when an unseen action is found by unseen action selector 108, when a number of new key frames have been stored in core set DB 106 that exceed a predetermined threshold, or when performance metrics such as classification accuracy determined by metrics analyzer 116 after analyzing performance of existing models and transfer policies 110 do not meet a desired predetermined threshold (e.g., the accuracy is below a desired level).

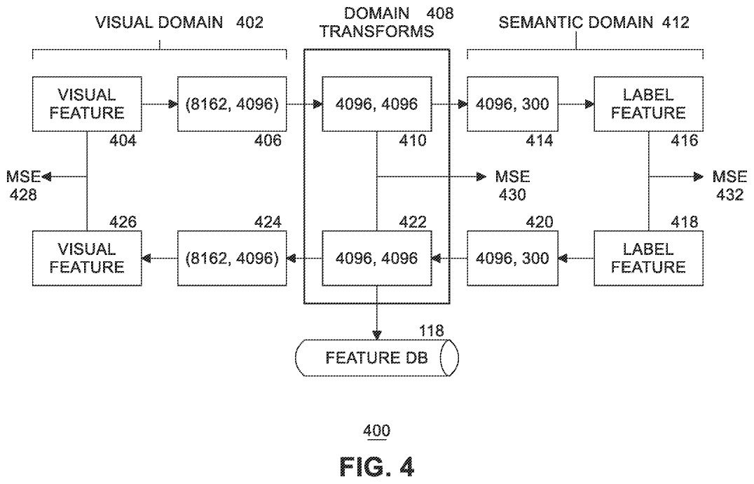

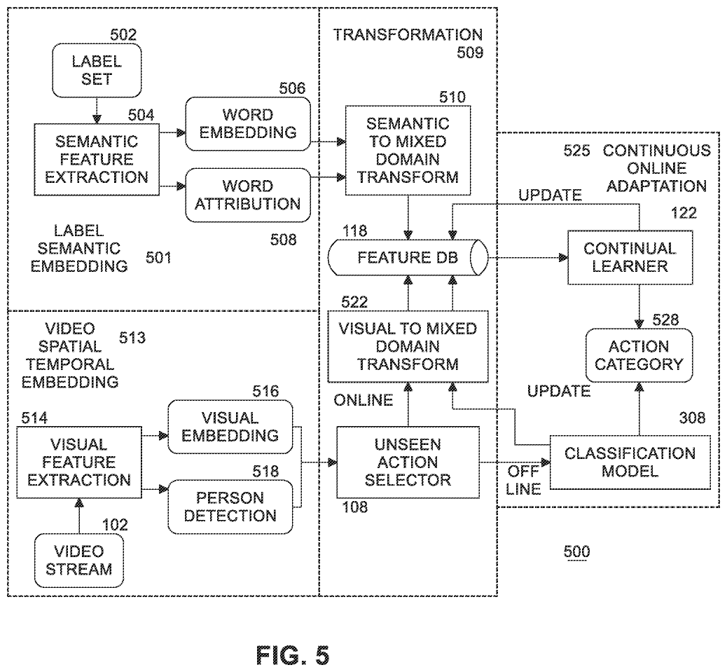

Continual learner 122 trains feature extraction models of models and transfer policies 110 online to adapt the domain transfer. For action feature extraction, the model is an I3D model 306. For semantic feature extraction, the model is a word to vector (W2V) model 304. Adaptation of domains for online learning is described below in FIGS. 4 and 5.

Continual learner 122 updates feature database 118 used by a classification model of models and transfer policies 110. In an embodiment, a self-training process is used as the online learning strategy. For each frame, when a feature is detected as a seen action, the mixed domain feature of this frame is stored in feature database 118. As used herein, a mixed domain is an intermediate representation between visual and semantic domains and a mixed domain feature is a transferred feature from either the visual or the semantic domains. If the feature is an unseen action, then continual learner 122 computes a cosine distance between the current mixed domain feature (denoted as X) and all features stored in feature database 118, then determines a “Top-1” feature (denoted as Y) in feature database 118. This finds the most similar feature vector in feature database 118. In an embodiment, this process is a K nearest neighbors (KNN) (K=1) algorithm. Continual learner 122 then outputs the label of Y as the final result (that is, the label of X).

The online learning strategy is also controlled by unseen action selector 108, which can help to directly update seen or unseen features in feature DB 118. In one embodiment, a K-nearest neighbors (KNN) process is used to update online features for unseen actions. For seen actions, an offline classifier is used to recognize and output an action category for a feature. The KNN is used to update weights and/or parameters of deep learning (DL) models in models and transfer policies 110.

Feature database 118 includes feature data extracted from images. In an embodiment, each entry in the database includes at least two items: a mixed domain feature and a corresponding action category.

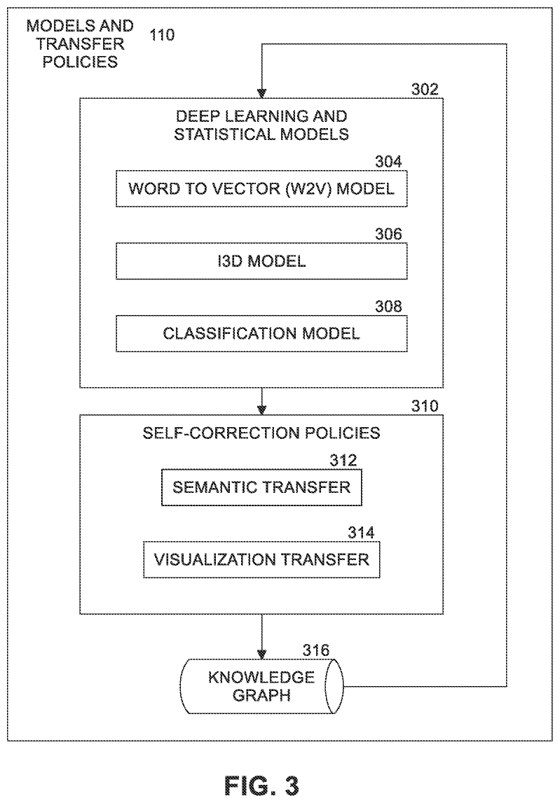

FIG. 3 is a diagram of models and transfer policies 110 according to some embodiments. Models and transfer policies 110 includes at least one offline model that can discern seen and unseen actions based on video stream 102 and semantic labels. In an embodiment, this component includes three modules: 1) deep learning (DL) and statistical models 302; 2) self-correction policies 310; and 3) knowledge graph 316.

DL and statistical models 302, when applied, extract semantic features and visualization features from semantic labels and video stream 102. Semantic labels are provided by a human analyst who watches video streams and annotates the actions seen in the video stream. Thus, semantic labels are a semantic description of action categories, such as “person walking,” “applying eye makeup,” “person sky diving,” “person getting a haircut” and so on.

In one embodiment, I3D model 306 (as described in “Quo Vadis Action Recognition? A New Model and Kinetics Dataset” by Jãao Carreira et al., published Feb. 12, 2018, Cornell University) is pretrained on a large dataset of video streams such as Kinetics400 (available on the Internet from DeepMind.com) and is subsequently used to generate visualization features from input video stream 102. Specifically, the input video stream 102 and its optical flow are fed into the I3D model to extract spatial-temporal features. The spatial-temporal features are then flattened and concatenated after pooling these features in the spatial dimension and averaging the features across the temporal dimension to get the visualization feature. Optical flow refers to an image extracted from two consecutive frames of the video stream, in which each pixel indicates the motion direction and velocity of the original RGB pixel.

Word to Vector (W2V) model 304 operates on input semantic labels (including human analyst-annotated phrases (e.g., person walking, person skydiving, etc.)) and outputs 300-dimension word vectors as the semantic features based on the input semantic labels. A W2V model is a technique for natural language processing (NLP). The W2V process uses a neural network model to learn word associations from a large corpus of text (as used herein, the text includes the semantic labels). Once trained, such a model can detect synonymous words or suggest additional words for a partial sentence. As the name implies, W2V represents each distinct, word with a particular list of numbers called a vector. The vectors are chosen carefully such that a simple mathematical function (the cosine similarity) between the vectors indicates the level of semantic similarity between the words represented by those vectors. In an embodiment, W2V model 304 is not retrained or updated. Embodiments use the pretrained W2V model to extract features of the input semantic action category (such as “apply eye makeup”, for example).

Classification model 308 is used to infer the labels of unseen actions. Classification model 308 updates feature DB 118 containing the seen and unseen semantic features. In an embodiment, an unseen action label is inferred by applying a K nearest neighbors (KNN) algorithm, which compares input visualization features (e.g., mixed domain features) with feature DB 118 and chooses the most similar feature as the predicted action label. Classification model 308 outputs the action category corresponding to the predicted action label. In other words, classification model 308 uses the action category of the nearest samples in feature DB 118 as the action category of detected actions in a testing video stream. In an embodiment, classification model 308 recognizes human actions using a video action transformer network (VTN) as described in “Video Action Transformer Network” by Rohit Girdhar, et al., published May 17, 2019, and available on the Internet at rohitgirdhar.github.io*ActionTransformer (“/” has been replaced with “*” to deter live hyperlinks).

Self-correction policies module 310 transforms the domain of detected features of the feature DB 118 of classification model 308 such that the feature DB is usable for both the semantic feature and visualization features. The domains of semantic features and visualization features are transformed into a mixed domain by semantic transfer 312 and visualization transfer 314. The mixed domain guarantees consistency for corresponding visualization features and semantic features. In addition, features in the mixed domain need to be able to be transferred back to their corresponding semantic domain and visualization domain. In an embodiment, self-correcting policies 310 operate as two auto-encoders, one to encode a visualization feature into a mixed domain feature and decode a mixed domain feature into a semantic feature, the other to encode a semantic feature into a mixed domain feature and decode a mixed domain feature into a visualization feature.

FIG. 4 illustrates domain transformations 400 for visual, semantic and mixed features according to some embodiments. The upper half of FIG. 4 illustrates the process of transforming features from visual to semantic and the lower half of FIG. 4 illustrates the process of transforming features from semantic to visual. Then, action recognition system 100 imposes three consistency loss on visual/semantic and mixed domain for training purposes. In testing, only half of the pipeline of FIG. 4 is used at a time: semantic transfer to the mixed domain in blocks 418, 420 and 422, and visual transfer to the mixed domain in blocks 404, 406 and 410. A visual feature 404 is passed to a fully-connected layer, and the output dimension is (8162×4096), then the visual feature continues to pass with two consecutive fully-connected layers, with output size=(4096, 4096) and (4096, 300). Then the feature continues to pass to a fully-connected layer to get label feature 416 of size=(1,300). Similarly, label features can be transformed into visual features. Mean squared error (MSE) 428, 430, and 432 are means of L2 distance in Euclidean space. MSE is used in training, as a loss to supervise the training process and search for the best model parameters. In ML training, the model is well trained (or the model parameter is converged) once the loss gets its global minimal value.

Returning back to FIG. 3, knowledge graph 316 stores a semantic tree of action types. In knowledge graph 316, a node represents a word (e.g., action) and an edge represents a similarity between two words (actions). For example, in an indoor scene in video steam 102, the action “sit” may be related to actions such as “reading” or “playing computer,” while in an outdoor scene in video stream 102, the action “sit” may be related to actions such as “playing cell-phone” or “talking.” In an embodiment, use of the knowledge graph 316 can replace or be a supplement to word embedding knowledge 506 discussed below. The design of knowledge graph 316 is to capture the similarity between semantic inputs, like W2V 304. Then, in one embodiment, the similarity from both W2V and knowledge graph may be integrated.

FIG. 5 is a flow diagram 500 of an action recognition system 100 according to some embodiments. Prior to an offline model training phase, video streams 102 are analyzed by human analysts and perceived actions portrayed in the video streams as detected by the humans are manually labeled with action identifiers (IDs). The collection of detected and annotated actions is called label set 502. During a first step of the training phase, all offline models (e.g., W2V 304, YOLO, I3D 306, and VTN 308) are trained before online deployment. The offline models are fixed as a result of the training phase and are not updated during online deployment.

During a second step of the training phase, feature database 118 is initialized. Each entry in feature database 118 includes a feature detected from video stream 102 and an associated action ID. In an embodiment, action ID and action label/category correlated (e.g., action ID is a unique ID for each action. For example, “applying eye makeup” is 0, “sky diving” is 1, and so on).

In an embodiment, a plurality of training video streams is analyzed in order to populate the initial data in the feature database. First, given a set of action labels in label set 502 and trained W2V model 304, semantic feature extraction 504 is performed using the W2V model to determine word embedding 506 and word attribution 508 as shown in label semantic embedding section 501, and features of all input semantic action labels/categories are outputted. This is performed once for each training video stream. In an embodiment, action categories are as defined in “UCF101—Action Recognition Data Set”, available from the University of Central Florida on the Internet at www.ucf.edu*data*UCF101.php (“/” has been replaced with “*” to disable hyperlinks). Word embedding 506 is extracted from input action textural descriptions. Similar to visual embedding, word embedding represents the semantics of input action text descriptions and similar words have similar embedding representations. Word attributes resulting from word attribution 508 are predefined and manually labeled. In one embodiment, the attributes provided by the UCF 101 dataset are used.

Next, visual feature extraction 514 is performed on training video streams using a trained I3D model 306 to determine visual embedding 516 and person detection 518 as shown in video spatial temporal embedding section 513. Visual embedding is an abstract representation of appearance features in video. Person detection is to locate a person with a bounding box in the frame of the video stream and extract an abstract feature representation of the bounding box area in the frame. Thus, video spatial temporal embedding 513 outputs the visual features of the training video streams.

Next, the outputs of semantic feature extraction 504 (e.g., word embedding 506 and word attribution 508) are transformed by semantic to mixed domain transform 510 of transformation section 509 and stored in feature DB 118. Similarly, the outputs of visual feature extraction 514 (e.g., visual embedding 516 and person detection 518) are transformed by visual to mixed domain transformation 522 of transformation section 509 and stored in feature DB 118.

During online deployment of action recognition system 100, given a set of action labels in label set 502 and trained W2V model 304, semantic feature extraction 504 is performed using the W2V model to determine word embedding 506 and word attribution 508 as shown in label semantic embedding section 501, and features of all input verbs are outputted to semantic to mixed domain transform 510. In an embodiment, action categories are as defined in “UCF101—Action Recognition Data Set”, available from the University of Central Florida on the Internet at www.ucf.edu*data*UCF101.php (“/” has been replaced with “*” to disable hyperlinks).

During online deployment of action recognition system 100, visual feature extraction 514 is performed on video stream 102 using trained I3D model 306 to determine visual embedding 516 and person detection 518 as shown in video spatial temporal embedding section 513. Thus, this step outputs the visual features of video stream 102.

The outputs of semantic feature extraction 504 (e.g., word embedding 506 and word attribution 508) are transformed by semantic to mixed domain transform 510 of transformation section 509 and stored in feature DB 118.

Given the visual features extracted from video stream 102 (e.g., visual embedding 516 and person detection 518), unseen action selector 108 determines if an action represented by an input feature has been seen in training video streams or has not yet been seen in training video streams (e.g., the action is “unseen”).

If the action has already been seen in a training video stream, offline processing is performed by offline classification model 308 (e.g., a VTN model as described above) using visual embedding 516 and person detection 518 and offline classification model 308 stores the feature and associated action ID in feature DB 118. Secondly, visual transformation is performed by visual to mixed domain transform 522 and the resulting mixed features are also stored in feature DB 118.

In an embodiment, activity category 528 is a translation of an action ID. Action IDs for identified actions can be converted to semantic labels. For example, if “action ID=0” is output by classification model 308, action recognition system 100 can convert the action ID=0 to an associated semantic label such as “apply eye makeup.”

If the action has not already been seen in a training video stream, visual transformation is performed by visual to mixed domain transform 522 and the resulting mixed features are also stored in feature DB 118. Next, given features in feature DB 118, continual learner 122 of action recognition system 100 of FIG. 1 performs a K-nearest neighbors (KNN) process to search feature DB 118 and outputs label IDs of nearest samples. Continual learner outputs action categories 528. The sample indicates a sample stored in feature DB 118. Inputs of continual learner 122 include mixed domain features (e.g., extracted online from the test video streams) and feature DB 118 (which is used to search for the nearest sample). For updates, continual learner 122 stores action IDs of identified unseen actions in feature DB 118.

In summary, for a test video, visual and semantic features are extracted first, then unseen action selector 108 determines where actions contained in the video stream are seen or unseen. If actions have been seen, then classification model 308 is used to output action IDs (correlated to action categories 528) and store mixed domain features and action IDs into feature DB 118. If actions are unseen, then the visual to mixed domain features are transferred using visual to mixed domain transform 522, and continual learner 122 (including a KNN) is used to search for similar features stored in feature DB 118, and continual learner 122 outputs the corresponding action IDs (correlated to action categories 528). Also, continual leaner 122 stores the action IDs for mixed domain features in feature DB 118.

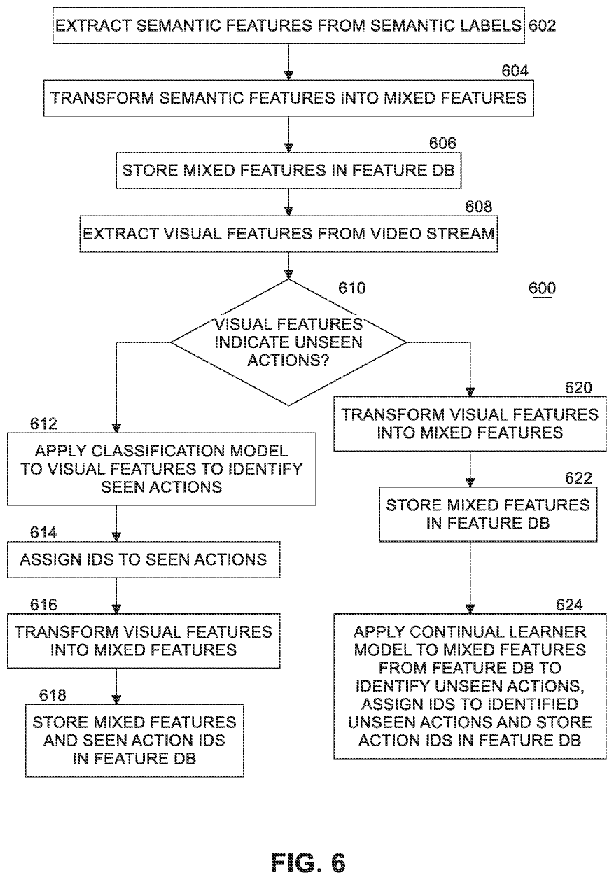

FIG. 6 is a flow diagram illustrating action recognition processing 600 according to some embodiments. At block 602, semantic feature extraction 504 extracts semantic features in a semantic domain from semantic action labels in label set 502. At block 604, semantic to mixed domain transform 510 transforms the semantic features from the semantic domain into a first set of mixed features in the mixed domain. At block 606, semantic to mixed domain transform 510 stores the first set of mixed features in feature DB 118. At block 608, visual feature extraction 514 extracts visual features in the visual domain from video stream 102. In an embodiment, performance of blocks 602-606 and block 608 are performed in parallel. At block 610, unseen action selector 108 determines if the visual features indicate one or more unseen actions in the video stream.

If no unseen actions are determined at block 610, at block 612 action recognition system 100 applies offline classification model 308 to the visual features to identify seen actions. At block 614, classification model 308 assigns identifiers (IDs) to the identified seen actions. At block 616, visual to mixed domain transform 522 transforms the visual features from the visual domain into a second set of mixed features in the mixed domain. At block 618, visual to mixed domain transform 522 stores the second set of mixed features and seen action IDs in feature DB 118.

If one or more unseen actions are determined at block 610, at block 620 visual to mixed domain transform 522 transforms the visual features from the visual domain into a third set of mixed features in the mixed domain. At block 622, visual to mixed domain transform 522 stores the third set of mixed features in feature DB 118. At block 624, action recognition system 100 applies continual learner model 122 to a fourth set of mixed features obtained from feature DB 118 to identify one or more unseen actions in video stream 102, assigns IDs to the identified unseen actions, and stores the unseen action IDs in feature DB 118.

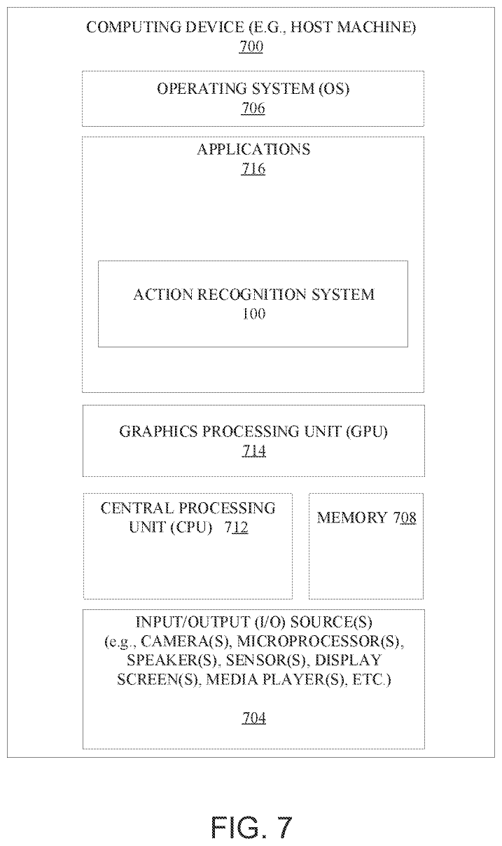

FIG. 7 illustrates one embodiment of a computing device 700 (e.g., a host machine) executing an application 716 for action recognition system 100. Computing device 700 (e.g., smart wearable devices, virtual reality (VR) devices, head-mounted display (HMDs), mobile computers, Internet of Things (IoT) devices, laptop computers, desktop computers, server computers, smartphones, etc.) is shown as hosting action recognition system 100.

In some embodiments, some or all of action recognition system 100 may be hosted by or part of firmware of graphics processing unit (GPU) 714. In yet other embodiments, some or all of action recognition system 100 may be hosted by or be a part of firmware of central processing unit (“CPU” or “application processor”) 712.

In yet another embodiment, action recognition system 100 may be hosted as software or firmware logic by operating system (OS) 706. In yet a further embodiment, action recognition system 100 may be partially and simultaneously hosted by multiple components of computing device 100, such as one or more of GPU 714, GPU firmware (not shown in FIG. 7), CPU 712, CPU firmware (not shown in FIG. 7), operating system 706, and/or the like. It is contemplated that action recognition system 100 or one or more of the constituent components may be implemented as hardware, software, and/or firmware.

Throughout the document, term “user” may be interchangeably referred to as “viewer”, “observer”, “person”, “individual”, “end-user”, and/or the like. It is to be noted that throughout this document, terms like “graphics domain” may be referenced interchangeably with “graphics processing unit”, “graphics processor”, or simply “GPU” and similarly, “CPU domain” or “host domain” may be referenced interchangeably with “computer processing unit”, “application processor”, or simply “CPU”.

Computing device 700 may include any number and type of communication devices, such as large computing systems, such as server computers, desktop computers, etc., and may further include set-top boxes (e.g., Internet-based cable television set-top boxes, etc.), global positioning system (GPS)-based devices, etc. Computing device 700 may include mobile computing devices serving as communication devices, such as cellular phones including smartphones, personal digital assistants (PDAs), tablet computers, laptop computers, e-readers, smart televisions, television platforms, wearable devices (e.g., glasses, watches, bracelets, smartcards, jewelry, clothing items, etc.), media players, etc. For example, in one embodiment, computing device 700 may include a mobile computing device employing a computer platform hosting an integrated circuit (“IC”), such as system on a chip (“SoC” or “SOC”), integrating various hardware and/or software components of computing device 700 on a single chip.

As illustrated, in one embodiment, computing device 700 may include any number and type of hardware and/or software components, such as (without limitation) GPU 714, a graphics driver (also referred to as “GPU driver”, “graphics driver logic”, “driver logic”, user-mode driver (UMD), UMD, user-mode driver framework (UMDF), UMDF, or simply “driver”) (not shown in FIG. 7), CPU 712, memory 708, network devices, drivers, or the like, as well as input/output (I/O) sources 704, such as touchscreens, touch panels, touch pads, virtual or regular keyboards, virtual or regular mice, ports, connectors, etc.

Computing device 700 may include operating system (OS) 706 serving as an interface between hardware and/or physical resources of the computer device 700 and a user. It is contemplated that CPU 712 may include one or more processors, such as processor(s) 702 of FIG. 7, while GPU 714 may include one or more graphics processors (or multiprocessors).

It is to be noted that terms like “node”, “computing node”, “server”, “server device”, “cloud computer”, “cloud server”, “cloud server computer”, “machine”, “host machine”, “device”, “computing device”, “computer”, “computing system”, and the like, may be used interchangeably throughout this document. It is to be further noted that terms like “application”, “software application”, “program”, “software program”, “package”, “software package”, and the like, may be used interchangeably throughout this document. Also, terms like “job”, “input”, “request”, “message”, and the like, may be used interchangeably throughout this document.

It is contemplated that some processes of the graphics pipeline as described herein are implemented in software, while the rest are implemented in hardware. A graphics pipeline (such as may be at least a part of action recognition system 100) may be implemented in a graphics coprocessor design, where CPU 712 is designed to work with GPU 714 which may be included in or co-located with CPU 712. In one embodiment, GPU 714 may employ any number and type of conventional software and hardware logic to perform the conventional functions relating to graphics rendering as well as novel software and hardware logic to execute any number and type of instructions.

Memory 708 may include a random-access memory (RAM) comprising application database having object information. A memory controller hub (not shown FIG. 7), may access data in the RAM and forward it to GPU 714 for graphics pipeline processing. RAM may include double data rate RAM (DDR RAM), extended data output RAM (EDO RAM), etc. CPU 712 interacts with a hardware graphics pipeline to share graphics pipelining functionality.

Processed data is stored in a buffer in the hardware graphics pipeline, and state information is stored in memory 708. The resulting image is then transferred to I/O sources 704, such as a display component for displaying of the image. It is contemplated that the display device may be of various types, such as Cathode Ray Tube (CRT), Thin Film Transistor (TFT), Liquid Crystal Display (LCD), Organic Light Emitting Diode (OLED) array, etc., to display information to a user.

Memory 708 may comprise a pre-allocated region of a buffer (e.g., frame buffer); however, it should be understood by one of ordinary skill in the art that the embodiments are not so limited, and that any memory accessible to the lower graphics pipeline may be used. Computing device 700 may further include an input/output (I/O) control hub (ICH) (not shown in FIG. 7), as one or more I/O sources 704, etc.

CPU 712 may include one or more processors to execute instructions in order to perform whatever software routines the computing system implements. The instructions frequently involve some sort of operation performed upon data. Both data and instructions may be stored in system memory 708 and any associated cache. Cache is typically designed to have shorter latency times than system memory 708; for example, cache might be integrated onto the same silicon chip(s) as the processor(s) and/or constructed with faster static RAM (SRAM) cells whilst the system memory 708 might be constructed with slower dynamic RAM (DRAM) cells. By tending to store more frequently used instructions and data in the cache as opposed to the system memory 708, the overall performance efficiency of computing device 700 improves. It is contemplated that in some embodiments, GPU 714 may exist as part of CPU 712 (such as part of a physical CPU package) in which case, memory 708 may be shared by CPU 712 and GPU 714 or kept separated.

System memory 708 may be made available to other components within the computing device 700. For example, any data (e.g., input graphics data) received from various interfaces to the computing device 700 (e.g., keyboard and mouse, printer port, Local Area Network (LAN) port, modem port, etc.) or retrieved from an internal storage element of the computer device 700 (e.g., hard disk drive) are often temporarily queued into system memory 708 prior to being operated upon by the one or more processor(s) in the implementation of a software program. Similarly, data that a software program determines should be sent from the computing device 700 to an outside entity through one of the computing system interfaces, or stored into an internal storage element, is often temporarily queued in system memory 708 prior to its being transmitted or stored.

Further, for example, an ICH may be used for ensuring that such data is properly passed between the system memory 708 and its appropriate corresponding computing system interface (and internal storage device if the computing system is so designed) and may have bi-directional point-to-point links between itself and the observed I/O sources/devices 704. Similarly, an MCH may be used for managing the various contending requests for system memory 708 accesses amongst CPU 712 and GPU 114, interfaces and internal storage elements that may proximately arise in time with respect to one another.

I/O sources 704 may include one or more I/O devices that are implemented for transferring data to and/or from computing device 700 (e.g., a networking adapter); or, for a large scale non-volatile storage within computing device 700 (e.g., hard disk drive). User input device, including alphanumeric and other keys, may be used to communicate information and command selections to GPU 714. Another type of user input device is cursor control, such as a mouse, a trackball, a touchscreen, a touchpad, or cursor direction keys to communicate direction information and command selections to GPU 714 and to control cursor movement on the display device. Camera and microphone arrays of computer device 700 may be employed to observe gestures, record audio and video and to receive and transmit visual and audio commands.

Computing device 700 may further include network interface(s) to provide access to a network, such as a LAN, a wide area network (WAN), a metropolitan area network (MAN), a personal area network (PAN), Bluetooth, a cloud network, a mobile network (e.g., 3rd Generation (3G), 4th Generation (4G), etc.), an intranet, the Internet, etc. Network interface(s) may include, for example, a wireless network interface having antenna, which may represent one or more antenna(e). Network interface(s) may also include, for example, a wired network interface to communicate with remote devices via network cable, which may be, for example, an Ethernet cable, a coaxial cable, a fiber optic cable, a serial cable, or a parallel cable.

Network interface(s) may provide access to a LAN, for example, by conforming to IEEE 802.11b and/or IEEE 802.11g standards, and/or the wireless network interface may provide access to a personal area network, for example, by conforming to Bluetooth standards. Other wireless network interfaces and/or protocols, including previous and subsequent versions of the standards, may also be supported. In addition to, or instead of, communication via the wireless LAN standards, network interface(s) may provide wireless communication using, for example, Time Division, Multiple Access (TDMA) protocols, Global Systems for Mobile Communications (GSM) protocols, Code Division, Multiple Access (CDMA) protocols, and/or any other type of wireless communications protocols.

Network interface(s) may include one or more communication interfaces, such as a modem, a network interface card, or other well-known interface devices, such as those used for coupling to the Ethernet, token ring, or other types of physical wired or wireless attachments for purposes of providing a communication link to support a LAN or a WAN, for example. In this manner, the computer system may also be coupled to a number of peripheral devices, clients, control surfaces, consoles, or servers via a conventional network infrastructure, including an Intranet or the Internet, for example.

It is to be appreciated that a lesser or more equipped system than the example described above may be preferred for certain implementations. Therefore, the configuration of computing device 700 may vary from implementation to implementation depending upon numerous factors, such as price constraints, performance requirements, technological improvements, or other circumstances. Examples of the electronic device or computer system 700 may include (without limitation) a mobile device, a personal digital assistant, a mobile computing device, a smartphone, a cellular telephone, a handset, a one-way pager, a two-way pager, a messaging device, a computer, a personal computer (PC), a desktop computer, a laptop computer, a notebook computer, a handheld computer, a tablet computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, television, digital television, set top box, wireless access point, base station, subscriber station, mobile subscriber center, radio network controller, router, hub, gateway, bridge, switch, machine, or combinations thereof.

Embodiments may be implemented as any or a combination of: one or more microchips or integrated circuits interconnected using a parent board, hardwired logic, software stored by a memory device and executed by a microprocessor, firmware, an application specific integrated circuit (ASIC), and/or a field programmable gate array (FPGA). The term “logic” may include, by way of example, software or hardware and/or combinations of software and hardware.

Embodiments may be provided, for example, as a computer program product which may include one or more tangible non-transitory machine-readable media having stored thereon machine-executable instructions that, when executed by one or more machines such as a computer, network of computers, or other electronic devices, may result in the one or more machines carrying out operations in accordance with embodiments described herein. A tangible non-transitory machine-readable medium may include, but is not limited to, floppy diskettes, optical disks, CD-ROMs (Compact Disc-Read Only Memories), and magneto-optical disks, ROMs, RAMs, EPROMs (Erasable Programmable Read Only Memories), EEPROMs (Electrically Erasable Programmable Read Only Memories), magnetic or optical cards, flash memory, or other type of media/machine-readable medium suitable for storing machine-executable instructions.

Moreover, embodiments may be downloaded as a computer program product, wherein the program may be transferred from a remote computer (e.g., a server) to a requesting computer (e.g., a client) by way of one or more data signals embodied in and/or modulated by a carrier wave or other propagation medium via a communication link (e.g., a modem and/or network connection).

Machine Learning Overview

A machine learning algorithm is an algorithm that can learn based on a set of data. Embodiments of machine learning algorithms can be designed to model high-level abstractions within a data set. For example, image recognition algorithms can be used to determine which of several categories to which a given input belongs; regression algorithms can output a numerical value given an input; and pattern recognition algorithms can be used to generate translated text or perform text to speech and/or speech recognition.

An exemplary type of machine learning algorithm is a neural network. There are many types of neural networks; a simple type of neural network is a feedforward network. A feedforward network may be implemented as an acyclic graph in which the nodes are arranged in layers. Typically, a feedforward network topology includes an input layer and an output layer that are separated by at least one hidden layer. The hidden layer transforms input received by the input layer into a representation that is useful for generating output in the output layer. The network nodes are fully connected via edges to the nodes in adjacent layers, but there are no edges between nodes within each layer. Data received at the nodes of an input layer of a feedforward network are propagated (i.e., “fed forward”) to the nodes of the output layer via an activation function that calculates the states of the nodes of each successive layer in the network based on coefficients (“weights”) respectively associated with each of the edges connecting the layers. Depending on the specific model being represented by the algorithm being executed, the output from the neural network algorithm can take various forms.

Before a machine learning algorithm can be used to model a particular problem, the algorithm is trained using a training data set. Training a neural network involves selecting a network topology, using a set of training data representing a problem being modeled by the network, and adjusting the weights until the network model performs with a minimal error for all instances of the training data set. For example, during a supervised learning training process for a neural network, the output produced by the network in response to the input representing an instance in a training data set is compared to the “correct” labeled output for that instance, an error signal representing the difference between the output and the labeled output is calculated, and the weights associated with the connections are adjusted to minimize that error as the error signal is backward propagated through the layers of the network. The network is considered “trained” when the errors for each of the outputs generated from the instances of the training data set are minimized.

The accuracy of a machine learning algorithm can be affected significantly by the quality of the data set used to train the algorithm. The training process can be computationally intensive and may require a significant amount of time on a conventional general-purpose processor. Accordingly, parallel processing hardware is used to train many types of machine learning algorithms. This is particularly useful for optimizing the training of neural networks, as the computations performed in adjusting the coefficients in neural networks lend themselves naturally to parallel implementations. Specifically, many machine learning algorithms and software applications have been adapted to make use of the parallel processing hardware within general-purpose graphics processing devices.

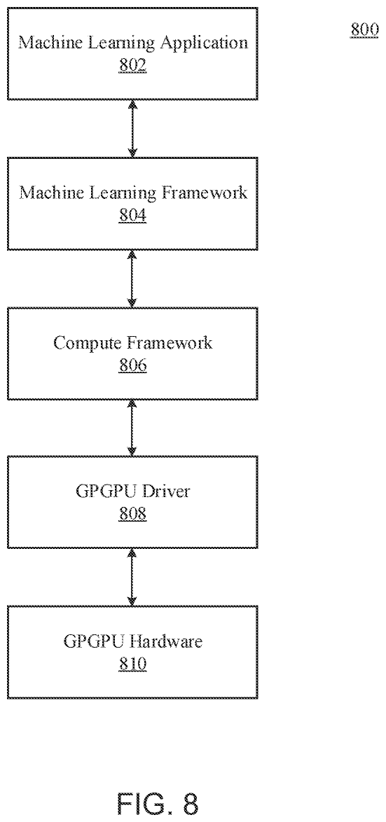

FIG. 8 is a generalized diagram of a machine learning software stack 800. A machine learning application 802 can be configured to train a neural network using a training dataset or to use a trained deep neural network to implement machine intelligence. The machine learning application 802 (such as action recognition system 100) can include training and inference functionality for a neural network and/or specialized software that can be used to train a neural network before deployment. The machine learning application 802 can implement any type of machine intelligence including but not limited to image recognition, mapping and localization, autonomous navigation, speech synthesis, medical imaging, or language translation.

Hardware acceleration for the machine learning application 802 can be enabled via a machine learning framework 804. The machine learning framework 804 can provide a library of machine learning primitives. Machine learning primitives are basic operations that are commonly performed by machine learning algorithms. Without the machine learning framework 804, developers of machine learning algorithms would be required to create and optimize the main computational logic associated with the machine learning algorithm, then re-optimize the computational logic as new parallel processors are developed. Instead, the machine learning application can be configured to perform the necessary computations using the primitives provided by the machine learning framework 804. Exemplary primitives include tensor convolutions, activation functions, and pooling, which are computational operations that are performed while training a convolutional neural network (CNN). The machine learning framework 804 can also provide primitives to implement basic linear algebra subprograms performed by many machine-learning algorithms, such as matrix and vector operations.

The machine learning framework 804 can process input data received from the machine learning application 802 and generate the appropriate input to a compute framework 806. The compute framework 806 can abstract the underlying instructions provided to a GPGPU driver 808 to enable the machine learning framework 804 to take advantage of hardware acceleration via the GPGPU hardware 810 without requiring the machine learning framework 804 to have intimate knowledge of the architecture of the GPGPU hardware 810. Additionally, the compute framework 806 can enable hardware acceleration for the machine learning framework 804 across a variety of types and generations of the GPGPU hardware 810.

Machine Learning Neural Network Implementations

The computing architecture provided by embodiments described herein can be configured to perform the types of parallel processing that is particularly suited for training and deploying neural networks for machine learning. A neural network can be generalized as a network of functions having a graph relationship. As is well-known in the art, there are a variety of types of neural network implementations used in machine learning. One exemplary type of neural network is the feedforward network, as previously described.

A second exemplary type of neural network is the Convolutional Neural Network (CNN). A CNN is a specialized feedforward neural network for processing data having a known, grid-like topology, such as image data. Accordingly, CNNs are commonly used for computer vision and image recognition applications, but they also may be used for other types of pattern recognition such as speech and language processing. The nodes in the CNN input layer are organized into a set of “filters” (e.g., filters are feature detectors inspired by the receptive fields found in the retina), and the output of each set of filters is propagated to nodes in successive layers of the network. The computations for a CNN include applying the convolution mathematical operation to each filter to produce the output of that filter. Convolution is a specialized kind of mathematical operation performed by two functions to produce a third function that is a modified version of one of the two original functions. In convolutional network terminology, the first function to the convolution can be referred to as the input, while the second function can be referred to as the convolution kernel. The output may be referred to as the feature map. For example, the input to a convolution layer can be a multidimensional array of data that defines the various color components of an input image. The convolution kernel can be a multidimensional array of parameters, where the parameters are adapted by the training process for the neural network.

Recurrent neural networks (RNNs) are a family of feedforward neural networks that include feedback connections between layers. RNNs enable modeling of sequential data by sharing parameter data across different parts of the neural network. The architecture for a RNN includes cycles. The cycles represent the influence of a present value of a variable on its own value at a future time, as at least a portion of the output data from the RNN is used as feedback for processing subsequent input in a sequence. This feature makes RNNs particularly useful for language processing due to the variable nature in which language data can be composed.

The figures described herein present exemplary feedforward, CNN, and RNN networks, as well as describe a general process for respectively training and deploying each of those types of networks. It will be understood that these descriptions are exemplary and non-limiting as to any specific embodiment described herein and the concepts illustrated can be applied generally to deep neural networks and machine learning techniques in general.

The exemplary neural networks described above can be used to perform deep learning. Deep learning is machine learning using deep neural networks. The deep neural networks used in deep learning are artificial neural networks composed of multiple hidden layers, as opposed to shallow neural networks that include only a single hidden layer. Deeper neural networks are generally more computationally intensive to train. However, the additional hidden layers of the network enable multistep pattern recognition that results in reduced output error relative to shallow machine learning techniques.

Deep neural networks used in deep learning typically include a front-end network to perform feature recognition coupled to a back-end network which represents a mathematical model that can perform operations (e.g., object classification, speech recognition, etc.) based on the feature representation provided to the model. Deep learning enables machine learning to be performed without requiring hand crafted feature engineering to be performed for the model. Instead, deep neural networks can learn features based on statistical structure or correlation within the input data. The learned features can be provided to a mathematical model that can map detected features to an output. The mathematical model used by the network is generally specialized for the specific task to be performed, and different models will be used to perform different tasks.

Once the neural network is structured, a learning model can be applied to the network to train the network to perform specific tasks. The learning model describes how to adjust the weights within the model to reduce the output error of the network. Backpropagation of errors is a common method used to train neural networks. An input vector is presented to the network for processing. The output of the network is compared to the desired output using a loss function and an error value is calculated for each of the neurons in the output layer. The error values are then propagated backwards until each neuron has an associated error value which roughly represents its contribution to the original output. The network can then learn from those errors using an algorithm, such as the stochastic gradient descent algorithm, to update the weights of the of the neural network.

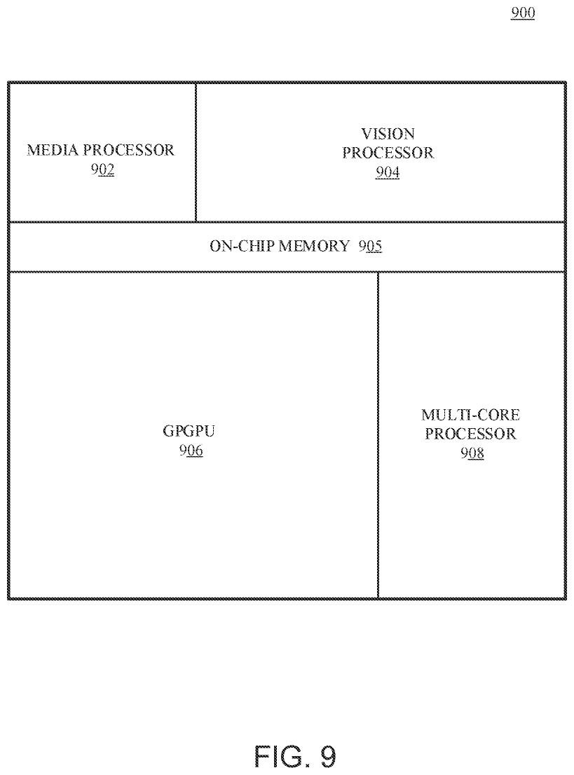

FIG. 9 illustrates an exemplary inferencing system on a chip (SOC) 900 suitable for performing inferencing using a trained model. One or more components of FIG. 9 may be used to implement action recognition system 100. The SOC 900 can integrate processing components including a media processor 902, a vision processor 904, a GPGPU 906 and a multi-core processor 908. The SOC 900 can additionally include on-chip memory 905 that can enable a shared on-chip data pool that is accessible by each of the processing components. The processing components can be optimized for low power operation to enable deployment to a variety of machine learning platforms, including autonomous vehicles and autonomous robots. For example, one implementation of the SOC 900 can be used as a portion of the main control system for an autonomous vehicle. Where the SOC 900 is configured for use in autonomous vehicles the SOC is designed and configured for compliance with the relevant functional safety standards of the deployment jurisdiction.

During operation, the media processor 902 and vision processor 904 can work in concert to accelerate computer vision operations (such as for action recognition system 100). The media processor 902 can enable low latency decode of multiple high-resolution (e.g., 4K, 8K) video streams. The decoded video streams can be written to a buffer in the on-chip-memory 905. The vision processor 904 can then parse the decoded video and perform preliminary processing operations on the frames of the decoded video in preparation of processing the frames using a trained image recognition model (e.g., models and transfer policies 110). For example, the vision processor 904 can accelerate convolution operations for a CNN that is used to perform image recognition on the high-resolution video data, while back end model computations are performed by the GPGPU 906.

The multi-core processor 908 can include control logic to assist with sequencing and synchronization of data transfers and shared memory operations performed by the media processor 902 and the vision processor 904. The multi-core processor 908 can also function as an application processor to execute software applications that can make use of the inferencing compute capability of the GPGPU 906. For example, at least a portion of the navigation and driving logic can be implemented in software executing on the multi-core processor 908. Such software can directly issue computational workloads to the GPGPU 906 or the computational workloads can be issued to the multi-core processor 908, which can offload at least a portion of those operations to the GPGPU 906.

Flowcharts representative of example hardware logic, machine readable instructions, hardware implemented state machines, and/or any combination thereof for implementing computing device 700, for example, are shown in FIGS. 5 and 6. The machine-readable instructions may be one or more executable programs or portion(s) of an executable program for execution by a computer processor such as the processor 714 shown in the example computing device 700 discussed above in connection with FIG. 7. The program may be embodied in software stored on a non-transitory computer readable storage medium such as a CD-ROM, a floppy disk, a hard drive, a DVD, a Blu-ray disk, or a memory associated with the processor 712, but the entire program and/or parts thereof could alternatively be executed by a device other than the processor 712 and/or embodied in firmware or dedicated hardware. Further, although the example program is described with reference to the flowcharts illustrated in FIGS. 5 and 6, many other methods of implementing the example action recognition system 100 may alternatively be used. For example, the order of execution of the blocks may be changed, and/or some of the blocks described may be changed, eliminated, or combined. Additionally or alternatively, any or all of the blocks may be implemented by one or more hardware circuits (e.g., discrete and/or integrated analog and/or digital circuitry, an FPGA, an ASIC, a comparator, an operational-amplifier (op-amp), a logic circuit, etc.) structured to perform the corresponding operation without executing software or firmware.

The machine-readable instructions described herein may be stored in one or more of a compressed format, an encrypted format, a fragmented format, a compiled format, an executable format, a packaged format, etc. Machine-readable instructions as described herein may be stored as data (e.g., portions of instructions, code, representations of code, etc.) that may be utilized to create, manufacture, and/or produce machine executable instructions. For example, the machine-readable instructions may be fragmented and stored on one or more storage devices and/or computing devices (e.g., servers). The machine readable instructions may require one or more of installation, modification, adaptation, updating, combining, supplementing, configuring, decryption, decompression, unpacking, distribution, reassignment, compilation, etc. in order to make them directly readable, interpretable, and/or executable by a computing device and/or other machine. For example, the machine readable instructions may be stored in multiple parts, which are individually compressed, encrypted, and stored on separate computing devices, wherein the parts when decrypted, decompressed, and combined form a set of executable instructions that implement a program such as that described herein.

In another example, the machine readable instructions may be stored in a state in which they may be read by a computer, but require addition of a library (e.g., a dynamic link library (DLL)), a software development kit (SDK), an application programming interface (API), etc. in order to execute the instructions on a particular computing device or other device. In another example, the machine readable instructions may be configured (e.g., settings stored, data input, network addresses recorded, etc.) before the machine readable instructions and/or the corresponding program(s) can be executed in whole or in part. Thus, the disclosed machine readable instructions and/or corresponding program(s) are intended to encompass such machine readable instructions and/or program(s) regardless of the particular format or state of the machine readable instructions and/or program(s) when stored or otherwise at rest or in transit.

The machine-readable instructions described herein can be represented by any past, present, or future instruction language, scripting language, programming language, etc. For example, the machine-readable instructions may be represented using any of the following languages: C, C++, Java, C#, Perl, Python, JavaScript, HyperText Markup Language (HTML), Structured Query Language (SQL), Swift, etc.

As mentioned above, the example process of FIGS. 5 and 6 may be implemented using executable instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc. may be present without falling outside the scope of the corresponding claim or recitation. As used herein, when the phrase “at least” is used as the transition term in, for example, a preamble of a claim, it is open-ended in the same manner as the term “comprising” and “including” are open ended.

The term “and/or” when used, for example, in a form such as A, B, and/or C refers to any combination or subset of A, B, C such as (1) A alone, (2) B alone, (3) C alone, (4) A with B, (5) A with C, (6) B with C, and (7) A with B and with C. As used herein in the context of describing structures, components, items, objects and/or things, the phrase “at least one of A and B” is intended to refer to implementations including any of (1) at least one A, (2) at least one B, and (3) at least one A and at least one B. Similarly, as used herein in the context of describing structures, components, items, objects and/or things, the phrase “at least one of A or B” is intended to refer to implementations including any of (1) at least one A, (2) at least one B, and (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, and (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, and (3) at least one A and at least one B.

As used herein, singular references (e.g., “a”, “an”, “first”, “second”, etc.) do not exclude a plurality. The term “a” or “an” entity, as used herein, refers to one or more of that entity. The terms “a” (or “an”), “one or more”, and “at least one” can be used interchangeably herein. Furthermore, although individually listed, a plurality of means, elements or method actions may be implemented by, e.g., a single unit or processor. Additionally, although individual features may be included in different examples or claims, these may possibly be combined, and the inclusion in different examples or claims does not imply that a combination of features is not feasible and/or advantageous.

Descriptors “first,” “second,” “third,” etc. are used herein when identifying multiple elements or components which may be referred to separately. Unless otherwise specified or understood based on their context of use, such descriptors are not intended to impute any meaning of priority, physical order or arrangement in a list, or ordering in time but are merely used as labels for referring to multiple elements or components separately for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for ease of referencing multiple elements or components.

The following examples pertain to further embodiments. Example 1 is an apparatus to perform action recognition. The apparatus of Example 1 comprises a processing device; and a memory device coupled to the processing device, the memory device having instructions stored thereon that, in response to execution by the processing device, cause the processing device to perform the following steps. The apparatus extracts semantic features in a semantic domain from semantic action labels, transforms the semantic features from the semantic domain into mixed features in a mixed domain, and stores the mixed features in a feature database. The apparatus extracts visual features in a visual domain from a video stream and determines if the visual features indicate an unseen action in the video stream. If no unseen action is determined, the apparatus applies an offline classification model to the visual features to identify seen actions, assigns identifiers to the identified seen actions, transforms the visual features from the visual domain into mixed features in the mixed domain, and stores the mixed features and seen action identifiers in the feature database. If an unseen action is determined, the apparatus transforms the visual features from the visual domain into mixed features in the mixed domain, applies a continual learner model to mixed features from the feature database to identify unseen actions in the video stream, assigns identifiers to the identified unseen actions, and stores the unseen action identifiers in the feature database.

In Example 2, the subject matter of Example 1 can optionally include wherein determining if the visual features indicate an unseen action in the video stream comprises applying a machine learning (ML) classifier with a binary output value.

In Example 3, the subject matter of Example 2 can optionally include wherein the ML classifier is trained using a generative adversarial network to generate unseen visualization features from semantic features.

In Example 4, the subject matter of Example 1 can optionally include wherein the continual learner model applies a K nearest neighbors process to the mixed features to identify unseen actions.

In Example 5, the subject matter of Example 1 can optionally include wherein the offline classification model recognizes human actions using a video action transformer network.

In Example 6, the subject matter of Example 1 can optionally include wherein semantic features are extracted, the semantic features are transformed into mixed features, and the mixed features are stored in the feature database, in a training phase.

In Example 7, the subject matter of Example 1 can optionally include wherein extracting visual features comprises applying an offline I3D classification model to the video stream.

In Example 8, the subject matter of Example 1 can optionally include wherein action identifiers are associated with action categories.

Example 9 is a method to perform action recognition. The method includes extracting semantic features in a semantic domain from semantic action labels, transforming the semantic features from the semantic domain into mixed features in a mixed domain, and storing the mixed features in a feature database; extracting visual features in a visual domain from a video stream; determining if the visual features indicate an unseen action in the video stream; if no unseen action is determined, applying an offline classification model to the visual features to identify seen actions, assigning identifiers to the identified seen actions, transforming the visual features from the visual domain into mixed features in the mixed domain, and storing the mixed features and seen action identifiers in the feature database; and if an unseen action is determined, transforming the visual features from the visual domain into mixed features in the mixed domain, applying a continual learner model to mixed features from the feature database to identify unseen actions in the video stream, assigning identifiers to the identified unseen actions, and storing the unseen action identifiers in the feature database.

In Example 10, the subject matter of Example 9 can optionally include wherein determining if the visual features indicate an unseen action in the video stream comprises applying a machine learning (ML) classifier with a binary output value.

In Example 11, the subject matter of Example 10 can optionally include training the ML classifier using a generative adversarial network to generate unseen visualization features from semantic features.

In Example 12, the subject matter of Example 9 can optionally include wherein the continual learner model applies a K nearest neighbors process to the mixed features to identify unseen actions.

In Example 13, the subject matter of Example 9 can optionally include wherein the offline classification model recognizes human actions using a video action transformer network.

In Example 14, the subject matter of Example 9 can optionally include wherein semantic features are extracted, the semantic features are transformed into mixed features, and the mixed features are stored in the feature database, in a training phase.

Example 15 is an action recognition apparatus. The apparatus of claim 15 comprises means for extracting semantic features in a semantic domain from semantic action labels, transforming the semantic features from the semantic domain into mixed features in a mixed domain, and storing the mixed features in a feature database; means for extracting visual features in a visual domain from a video stream; means for determining if the visual features indicate an unseen action in the video stream; if no unseen action is determined, means for applying an offline classification model to the visual features to identify seen actions, assigning identifiers to the identified seen actions, transforming the visual features from the visual domain into mixed features in the mixed domain, and storing the mixed features and seen action identifiers in the feature database; and if an unseen action is determined, means for transforming the visual features from the visual domain into mixed features in the mixed domain, applying a continual learner model to mixed features from the feature database to identify unseen actions in the video stream, assigning identifiers to the identified unseen actions, and storing the unseen action identifiers in the feature database.

In Example 16, the subject matter of Example 15 can optionally include means for determining if the visual features indicate an unseen action in the video stream comprises means for applying a machine learning (ML) classifier with a binary output value.

In Example 17, the subject matter of Example 15 can optionally include means for training the ML classifier using a generative adversarial network to generate unseen visualization features from semantic features.

In Example 18, the subject matter of Example 15 can optionally include wherein the continual learner model comprises means for applying a K nearest neighbors process to the mixed features to identify unseen actions.

In Example 19, the subject matter of Example 15 can optionally include wherein the offline classification model recognizes human actions using a video action transformer network.

In Example 20, the subject matter of Example 15 can optionally include wherein semantic features are extracted, the semantic features are transformed into mixed features, and the mixed features are stored in the feature database, in a training phase.

Example 21 is at least one non-transitory machine-readable storage medium comprising instructions that, when executed, cause at least one processor to perform action recognition. The at least one non-transitory machine-readable storage medium includes instructions to extract semantic features in a semantic domain from semantic action labels, transform the semantic features from the semantic domain into mixed features in a mixed domain, and store the mixed features in a feature database. The instructions extract visual features in a visual domain from a video stream and determine if the visual features indicate an unseen action in the video stream. If no unseen action is determined, the instructions apply an offline classification model to the visual features to identify seen actions, assign identifiers to the identified seen actions, transform the visual features from the visual domain into mixed features in the mixed domain, and store the mixed features and seen action identifiers in the feature database. If an unseen action is determined, the instructions transform the visual features from the visual domain into mixed features in the mixed domain, apply a continual learner model to mixed features from the feature database to identify unseen actions in the video stream, assign identifiers to the identified unseen actions, and store the unseen action identifiers in the feature database.

In Example 22, the subject matter of Example 21 can optionally include wherein instructions to determine if the visual features indicate an unseen action in the video stream comprise instructions to apply a machine learning (ML) classifier with a binary output value.

In Example 23, the subject matter of Example 22 can optionally include wherein the ML classifier is trained using a generative adversarial network to generate unseen visualization features from semantic features.

In Example 24, the subject matter of Example 21 can optionally include wherein the continual learner model applies a K nearest neighbors process to the mixed features to identify unseen actions.

In Example 25, the subject matter of Example 21 can optionally include wherein the offline classification model recognizes human actions using a video action transformer network.

In Example 26, the subject matter of Example 21 can optionally include wherein semantic features are extracted, the semantic features are transformed into mixed features, and the mixed features are stored in the feature database, in a training phase.

The foregoing description and drawings are to be regarded in an illustrative rather than a restrictive sense. Persons skilled in the art will understand that various modifications and changes may be made to the embodiments described herein without departing from the broader spirit and scope of the features set forth in the appended claims.

What is claimed is:

1. At least one computer-readable medium having stored thereon instructions which, when executed, cause a computing device to perform operations comprising:
extract semantic features in a semantic domain from semantic action labels, transform the semantic features from the semantic domain into mixed features in a mixed domain, and store the mixed features in a feature database;
extract visual features in a visual domain from a video stream;
determine if the visual features indicate an unseen action in the video stream;
if no unseen action is determined, apply an offline classification model to the visual features to identify seen actions, assign identifiers to the identified seen actions, transform the visual features from the visual domain into mixed features in the mixed domain, and store the mixed features and seen action identifiers in the feature database; and
if an unseen action is determined, transform the visual features from the visual domain into mixed features in the mixed domain, apply a continual learner model to mixed features from the feature database to identify unseen actions in the video stream, assign identifiers to the identified unseen actions, and store the unseen action identifiers in the feature database.

2. The computer-readable medium of claim 1, wherein determining if the visual features indicate an unseen action in the video stream comprises applying a machine learning (ML) classifier with a binary output value.

3. The computer-readable medium of claim 2, wherein the operations comprise training the ML classifier using a generative adversarial network to generate unseen visualization features from semantic features.

4. The computer-readable medium of claim 1, wherein the continual learner model applies a K nearest neighbors process to the mixed features to identify unseen actions.

5. The computer-readable medium of claim 1, wherein the offline classification model recognizes human actions using a video action transformer network.

6. The computer-readable medium of claim 1, wherein semantic features are extracted, the semantic features are transformed into mixed features, and the mixed features are stored in the feature database, in a training phase, wherein extracting visual features comprises applying an offline I3D classification model to the video stream.

7. The computer-readable medium of claim 1, wherein action identifiers are associated with action categories.

8. An apparatus comprising:
a processing device; and
a memory device coupled to the processing device, the memory device having instructions stored thereon that, in response to execution by the processing device, cause the processing device to:
extract semantic features in a semantic domain from semantic action labels, transform the semantic features from the semantic domain into mixed features in a mixed domain, and store the mixed features in a feature database;
extract visual features in a visual domain from a video stream;
determine if the visual features indicate an unseen action in the video stream;
if no unseen action is determined, apply an offline classification model to the visual features to identify seen actions, assign identifiers to the identified seen actions, transform the visual features from the visual domain into mixed features in the mixed domain, and store the mixed features and seen action identifiers in the feature database; and
if an unseen action is determined, transform the visual features from the visual domain into mixed features in the mixed domain, apply a continual learner model to mixed features from the feature database to identify unseen actions in the video stream, assign identifiers to the identified unseen actions, and store the unseen action identifiers in the feature database.

9. The apparatus of claim 8, wherein determining if the visual features indicate an unseen action in the video stream comprises applying a machine learning (ML) classifier with a binary output value, wherein the ML classifier is trained using a generative adversarial network to generate unseen visualization features from semantic features.

10. The apparatus of claim 8, wherein the continual learner model applies a K nearest neighbors process to the mixed features to identify unseen actions.

11. The apparatus of claim 8, wherein the offline classification model recognizes human actions using a video action transformer network.

12. The apparatus of claim 8, wherein semantic features are extracted, the semantic features are transformed into mixed features, and the mixed features are stored in the feature database, in a training phase, wherein extracting visual features comprises applying an offline I3D classification model to the video stream.

13. The apparatus of claim 8, wherein action identifiers are associated with action categories.

14. A method comprising:
extracting semantic features in a semantic domain from semantic action labels, transforming the semantic features from the semantic domain into mixed features in a mixed domain, and storing the mixed features in a feature database;
extracting visual features in a visual domain from a video stream;
determining if the visual features indicate an unseen action in the video stream;
if no unseen action is determined, applying an offline classification model to the visual features to identify seen actions, assigning identifiers to the identified seen actions, transforming the visual features from the visual domain into mixed features in the mixed domain, and storing the mixed features and seen action identifiers in the feature database; and
if an unseen action is determined, transforming the visual features from the visual domain into mixed features in the mixed domain, applying a continual learner model to mixed features from the feature database to identify unseen actions in the video stream, assigning identifiers to the identified unseen actions, and storing the unseen action identifiers in the feature database.

15. The method of claim 14, wherein determining if the visual features indicate an unseen action in the video stream comprises applying a machine learning (ML) classifier with a binary output value.

16. The method of claim 15, further comprising training the ML classifier using a generative adversarial network to generate unseen visualization features from semantic features.

17. The method of claim 14, wherein the continual learner model applies a K nearest neighbors process to the mixed features to identify unseen actions.

18. The method of claim 14, wherein the offline classification model recognizes human actions using a video action transformer network.

19. The method of claim 14, wherein semantic features are extracted, the semantic features are transformed into mixed features, and the mixed features are stored in the feature database, in a training phase, wherein extracting visual features comprises applying an offline I3D classification model to the video stream.

20. The method of claim 14, wherein action identifiers are associated with action categories.
